(19) United States
(12) Patent Application Publication
(10) Pub. No.: US 2013/0091026 A1
(43) Pub. Date: Apr. 11, 2013

(54) Photo Sharing with Digital Album

(71) Applicants: Hui Deng, San Ramon, CA (US); Jin Wang, Hangzhou (CN); Junming Sheng, Hangzhou (CN); Younghuang Wang, Hangzhou (CN); Fangmin Chen, Hangzhou (CN)

(72) Inventors: Hui Deng, San Ramon, CA (US); Jin Wang, Hangzhou (CN); Junming Sheng, Hangzhou (CN); Younghuang Wang, Hangzhou (CN); Fangmin Chen, Hangzhou (CN)

(73) Assignee: ARCSOFT, INC., Fremont, CA (US)

(21) Appl. No.: 13/316,470

(22) Filed: Dec. 10, 2011

Related U.S. Application Data
(60) Provisional application No. 61/545,573, filed on Oct. 10, 2011.

(51) Int. Cl. G06Q 30/06; G06Q 30/02; G06F 17/00

(52) U.S. Cl. 705/14.73; 715/205; 715/203; 705/26.5

(57) ABSTRACT

A user runs an album application on a digital device to generate a digital album and share the album with others. The album application creates a message with a first copy of the album and a link to a second copy of the album on a website hosted by a photo sharing provider. The first copy of the album is a small file because it contains low resolution versions of the photos and it uses a compact file format (e.g., Adobe Flash or HTML5). After the message is sent, the album application uploads high resolution versions of the photos to the photo sharing provider. A recipient of the message may view the first copy of the album in the message or click on the link to access the second copy of the album from the website hosted by the photo sharing provider. The recipient may order prints of the album from the photo sharing provider or a print provider working with the photo sharing provider. The recipient may further share the album by forwarding the message or the link to others.

### CROSS REFERENCE TO RELATED APPLICATIONS

This application claims the benefit of U.S. Provisional App. No. 61/545,573, attorney docket no. ARC-P184-PV, filed on Oct. 10, 2011, which is incorporated herein by reference.

### FIELD OF INVENTION

This invention relates to photo sharing between digital devices over a network.

### DESCRIPTION OF RELATED ART

To share photos captured on a mobile device, a user can email the photos directly to others. The user can also upload the photos to a photo sharing service provider and invite others to view the photos on the Internet via the photo sharing service provider.

### SUMMARY

In one or more embodiments of the present disclosure, a user runs an album application on a digital device to generate a digital album and share the album with others. The album application creates a message with a first copy of the album and a link to a second copy of the album on a website hosted by a photo sharing provider. The first copy of the album is a small file because it contains low resolution versions of the photos and it uses a compact file format (e.g., Adobe Flash or HTML5). After the message is sent, the album application uploads high resolution versions of the photos to the photo sharing provider. A recipient of the message may view the first copy of the album in the message or click on the link to access the second copy of the album from the website hosted by the photo sharing provider. The recipient may order prints of the album from the photo sharing provider or a print provider working with the photo sharing provider. The recipient may further share the album by forwarding the message or the link to others.

### BRIEF DESCRIPTION OF THE DRAWINGS

In the drawings:

FIG. 1 is a block diagram of a photo sharing system;

FIG. 2 is a flowchart of methods executed by processors on digital devices and a photo sharing provider server computer in the system of FIG. 1 to implement photo sharing;

FIG. 3 is a screenshot of a graphic user interface (GUI) for selecting an album template on an album client application;

FIGS. 4A, 4B, and 4C are screenshots of the GUI displaying an album;

FIG. 5 is a screenshot of the GUI for selecting to order prints and share the album;

FIG. 6 shows a message generated by the album client application for sharing the album;

FIG. 7 is a screenshot of a web page with a copy of the album served by a photo sharing provider server computer; and

FIG. 8 is a screenshot of the web page for selecting to order prints and share the album, all arranged according to embodiments of the present disclosure.

Use of the same reference numbers in different figures indicates similar or identical elements.

### DETAILED DESCRIPTION

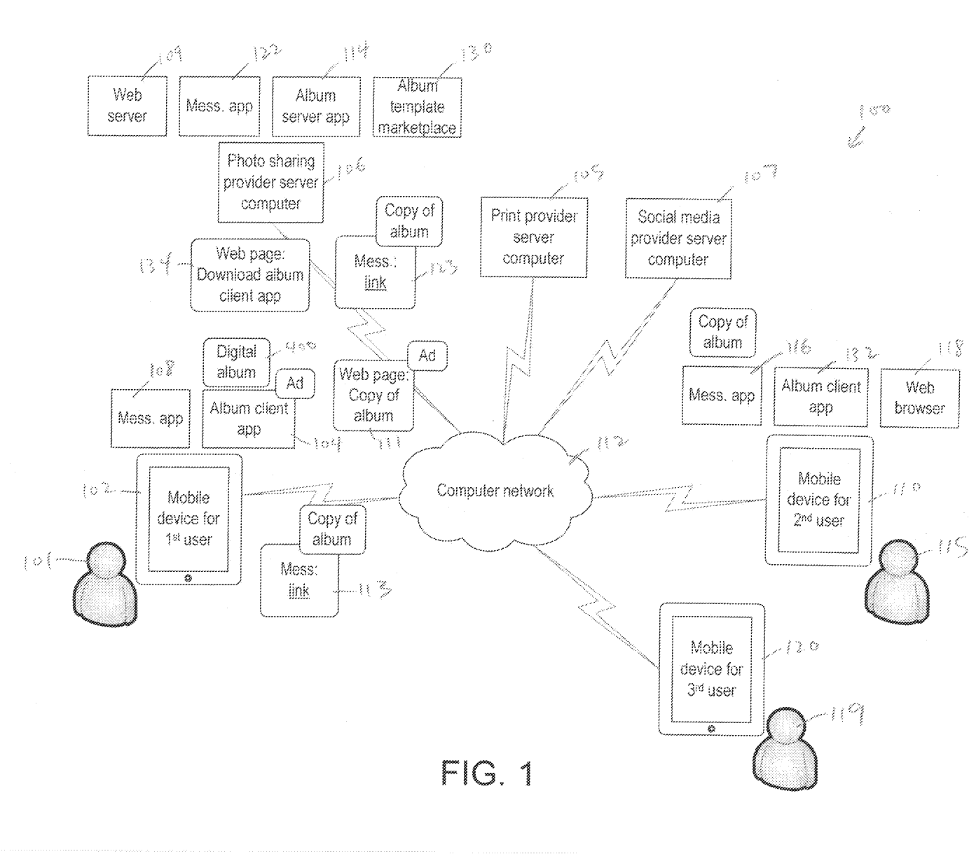

FIG. 1 is a block diagram of a photo sharing system 100 in one or more embodiments of the present disclosure. A first user 101 runs an album client application 104 on a digital device 102 to share media with others. First user 101 may capture new media using digital device 102 or upload preexisting media to the digital device. Examples of the media include photos, videos, and sounds. For simplicity, photos are used to illustrate system 100. Digital device 102 may be a mobile device such as a smart phone such as the iPhone® or a tablet computer such as the iPad®. Digital device 102 may also be a laptop computer, a desktop computer, a digital television, or a set top box.

Using album client application 104, first user 101 selects photos and an album template. Album client application 104 automatically creates an interactive digital album from the selected photos and the selected album template.

The album template specifies the backgrounds on the album pages, the photo containers or frames on the album pages, and the transition effects between the album pages. For the photo containers, the album template specifies their layouts, orientations (portrait or landscape), and sizes. The album template may specify the order of the album pages but album client application 104 may rearrange and reuse the album pages depending on the total number and the orientations of the selected photos.

As the photo containers are smaller than the full resolution of the photos, album client application 104 creates low resolution versions of the photos to fill the photo containers. Low resolution may be, for example, 640 by 480 pixels.

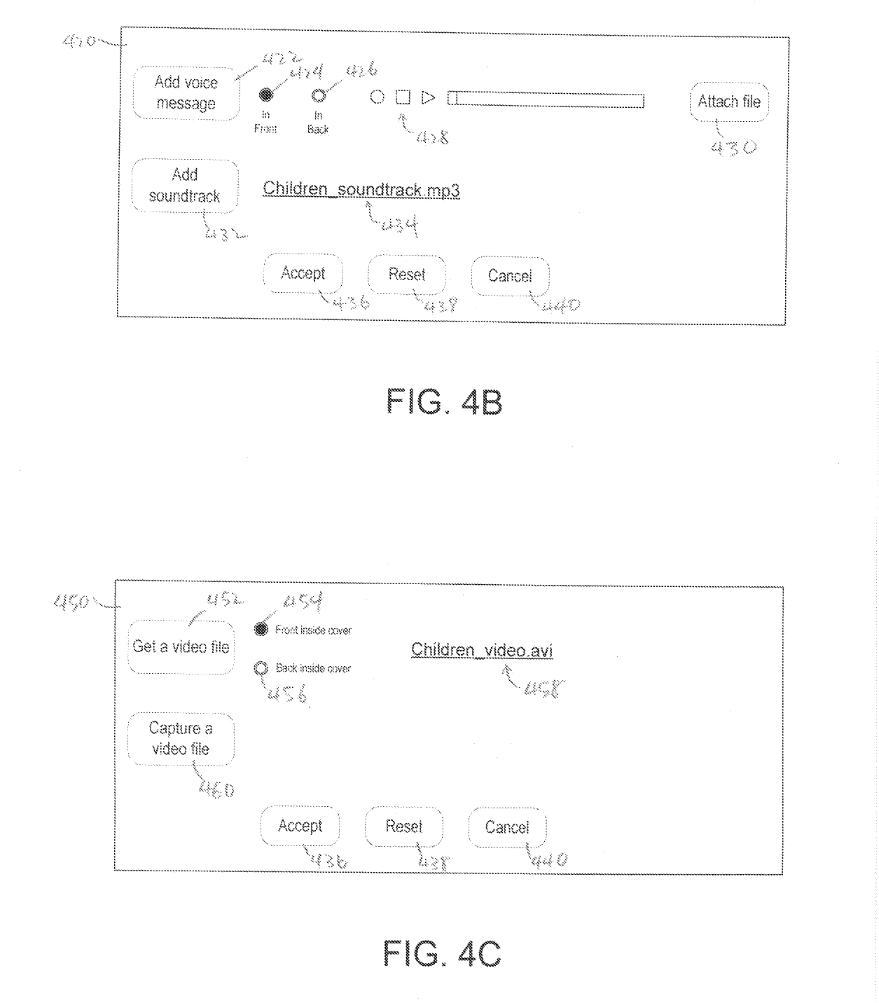

Album client application 104 may generally arrange the photos based on time/date taken. Album client application 104 may group together photos that are similar (e.g., sum of absolute differences for any two consecutive photos is less than a threshold) and taken within a short time span of each other (e.g., any two consecutive photos that are within five seconds of each other or photos taken using the burst mode). Instead of displaying these similar photos individually, they may be displayed as a stack of photos in one photo container so they may be flipped through by clicking on the stack (e.g., FIG. 4A shows a stack 419 of similar photos taken within a short time span of each other).

Album client application 104 may optimize the number and the order of the album pages to best match the number and the orientations of the arranged photos. Album client application 104 may detect faces in the photos and locate the photos in the photo containers so the detected faces are within the viewable areas of the photo containers.

Album client application 104 displays the digital album on the screen of digital device 102 for first user 101 to view and edit the digital album (e.g., moving and deleting photos, sizing photos, and inserting captions for photos). The digital album includes next and previous buttons to navigate through the album pages. Based on the first user's edits on an album page, such as moving or deleting photos, album client application 104 may again optimize the number and the order of the album pages to best match the number and the orientations of the arranged photos.

Album client application 104 provides an option for first user 101 to order a physical copy of the digital album, prints from the digital album, or other physical media of the digital album. When first user 101 selects to order, album client application 104 provides additional interfaces for the first user to provide ordering information. For example, the additional interfaces allow first user 101 to select photos, print sizes, and print quantities, and provide payment information and shipping information. Album client application 104 then uploads the order information and high resolution versions of the photos (if not already uploaded for sharing as described later) to a secure server computer 106 of a photo sharing provider (described more later) to fulfill the order. The photos are uploaded at high resolution to ensure high quality prints. High resolution may be 1024 by 768 pixels, 1600 by 1200 pixels, or greater. The uploaded photos also act as backup copies to the photos on the first user's digital device 102. The photo sharing provider may fulfill the order itself or contract it out to a print provider. Alternatively album client application 104 may transmit the order information and the photos to a secure server computer 105 of the print provider to fulfill the order.

Album client application 104 provides an option for first user 101 to share the album. When first user 101 selects to share the digital album, album client application 104 provides options for the first user to allow others to order physical media of the digital album, and to share the digital album through a social media provider or by messaging (e.g., an email or an instant message). Social media providers include blog providers such as Twitter and social networking providers such as Facebook. When first user 101 selects to share the digital album through a social media provider, album client application 104 transmits a hyperlink to the digital album on a web page 111 to a secure server computer 107 of the social media provider, which posts the hyperlink to the first user's account so others can click the link to view a copy of the digital album on the web. Web page 111 is hosted by photo sharing provider server computer 106 (described more later). Alternatively album client application 104 transmits a copy of the digital album or the low resolution photos in the digital album to social media provider server computer 107, which posts the digital album or the low resolution photos to the first user's account for others to view. Album client application 104 has the appropriate application programming interface to communicate with social media provider server computer 107.

When first user 101 selects to share the digital album by messaging, album client application 104 creates the hyperlink to web page 111 hosted by photo sharing provider server computer 106. Album client application 104 creates a copy of the digital album, causes a messaging application 108 on digital device 102 (or another device for web-based email or instant messaging) to create a message 113, inserts the hyperlink into the body of the message, and attaches the copy of the digital album to the message.

The copy of the digital album may be a rich media file that can be viewed on a browser with the appropriate plug-in or a standalone viewer. For example, the rich media file may be an Adobe Flash file that can be viewed on a browser with the Adobe Flash Player plug-in or standalone player, or an HTML5 file that can be viewed on a browser. Alternatively the rich media file is self-extracting or self-executing so it can be independently viewed without a browser or a standalone viewer. For example, the rich media file may be a Flash projector file. The rich media file is small in size due to its format and also because the photos in the digital album are low resolution.

Assume first user 101 wishes to share the album with a second user 115 of a digital device 110, which may be on a different platform than digital device 102 of the first user. The first user fills in the second user's messaging address on message 113 and causes messaging application 108 to send the message from digital device 102 to digital device 110 over a computer network 112. Computer network 112 may represent one or more coupled networks, such as the Internet and mobile networks.

In the background about the same time or immediately after the sharing (whether by message or through a social media provider), album client application 104 uploads the photos, an identification of the album template, the layout information of the digital album (e.g., photo arrangements, photo sizes, and photo captions), and the hyperlink to photo sharing provider server computer 106 over computer network 112. The photos are typically transmitted in their full resolution to preserve their details for printing and backup purposes. If first user 101 does not allow others to order physical media of the digital album, album client application 104 may upload the photos in low resolution. An album server application 114 on photo sharing provider server computer 106 recreates the digital album from the photos, the album template, and the layout information of the digital album.

Second user 115 receives message 113 with a messaging application 116 on digital device 110 (or another device for web-based email or instant messaging). From message 113, second user 115 may select to view the copy of the digital album attached to the message or select the hyperlink in the message body to view the copy of the digital album on web page 111 through a web browser 118 on digital device 110. When second user 115 selects the hyperlink, web browser 118 requests web page 111 from photo sharing provider server computer 106. In response, a web server 109 creates and serves web page 111 including the copy of the digital album. Web server 109 may be located on photo sharing provider server computer 106 or another server computer. Web page 111 is small in size due to its format and also because the photos in the digital album are low resolution. Web server 109 may detect the type of web browser 118 and the platform it is running on, and create web page 111 that is most compatible for viewing on the web browser.

Web page 111 provides an option for second user 115 to order a physical copy of the digital album, prints from the digital album, or other physical media of the digital album. When second user 115 selects to order, web server 109 provides additional web pages for the second user to provide ordering information. As discussed before, the photo sharing provider may fulfill the order itself or contract it out to a print provider. Photo sharing provider server computer 106 may account and distribute payments received for physical media of the digital album among the photo sharing provider, the print provider if any, and the owner of the digital album (first user 101).

Web page 111 provides an option for second user 115 to share the digital album. When second user 115 selects to share the digital album, web page 111 further provides options for the second user to share through social media providers or by messaging. When second user 115 selects to share the digital album through a social media provider, web browser 118 sends the request to photo sharing provider server computer 106. In response, album server application 114 transmits a copy of the digital album, the low resolution photos in the digital album, or the hyperlink to web page 111 to social media provider server computer 105, which posts the copy of the digital album, the low resolution photos in the digital album, or the link to the second user's account.

When second user 115 wishes to share the album by messaging, web browser 118 sends the request to photo sharing provider server computer 106. Assume second user 115 wishes to share with a third user 119 of a digital device 120, which may be on a different platform than digital device 110 of the second user. In response, album server application 114 creates a copy of the digital album, causes a messaging application 122 to create a message 123, includes the hyperlink in the body of the message, attaches the copy of the digital album to the message, and sends the message to third user 119. The sharing experience for third user 119 is similar to that of second user 115 described above where the third user is able to view the copy of the digital album in the message, view the copy of the digital album in web page 111, order physical media, and further share the digital album. Messaging application 122 may be located on photo sharing provider server computer 106 or another server computer.

In some embodiments, second user 115 has access to the shared photos from first user 101 via photo sharing provider server computer 106 and can create her digital album using any of the share photos. In some embodiments, second user 115 can add her photos to the digital album via photo sharing provider server computer 106.

Each computer device in FIG. 1 includes a processor, a nonvolatile memory for storing application codes, and a volatile memory for temporarily storing the application codes and application data during runtime. Each digital device further includes a display to view the graphical user interface (GUI) of the applications, and a user input device to receive user inputs.

As described above, system 100 maintains high and low-resolution versions of the digital album based on the intended use. A digital album with low resolution photos is used for viewing and sharing. High-resolution photos are maintained for printing and backup purposes. System 100 reduces unnecessary file transfers of high resolution photos by optimizing the use of the network resources depending on needs.

The digital album with low resolution photos may be used to achieve rapid, viral-like sharing. The digital album allows anyone that likes the digital album to share with others and order printed albums or photos if permitted by the owner of the digital album. Upon receiving an order, system 100 uses the high resolution photos for printing.

System 100 provides an internet-based publishing and printing hub for personal photo albums, professional photo books, and other photo-intensive printing materials. For example, a professional photographer may publish and sell her works through digital albums using system 100 instead of going through a traditional publisher with the upfront cost of conventional publishing.

Photo sharing provider server computer 106 may be configured to provide a marketplace 130 where third parties submit album templates for others to purchase. Photo sharing provider server computer 106 may provide tools to the third parties to build album templates for a variety of topics and themes, such as travel, baby, fashion, wedding, and calendar. The third parties then upload the album templates to photo sharing provider server computer 106, which makes them available for purchase and download to other users.

Album client application 104 and album server application 114 may also provide targeted advertisements to users based on the use of the software, such as the topics/themes and the authors/publishers of the selected album templates. For example, a user using a baby themed album template may be provided with baby product advertisements. Such advertisements may appear as banner ads within the interface of album client application 104 and web pages 111.

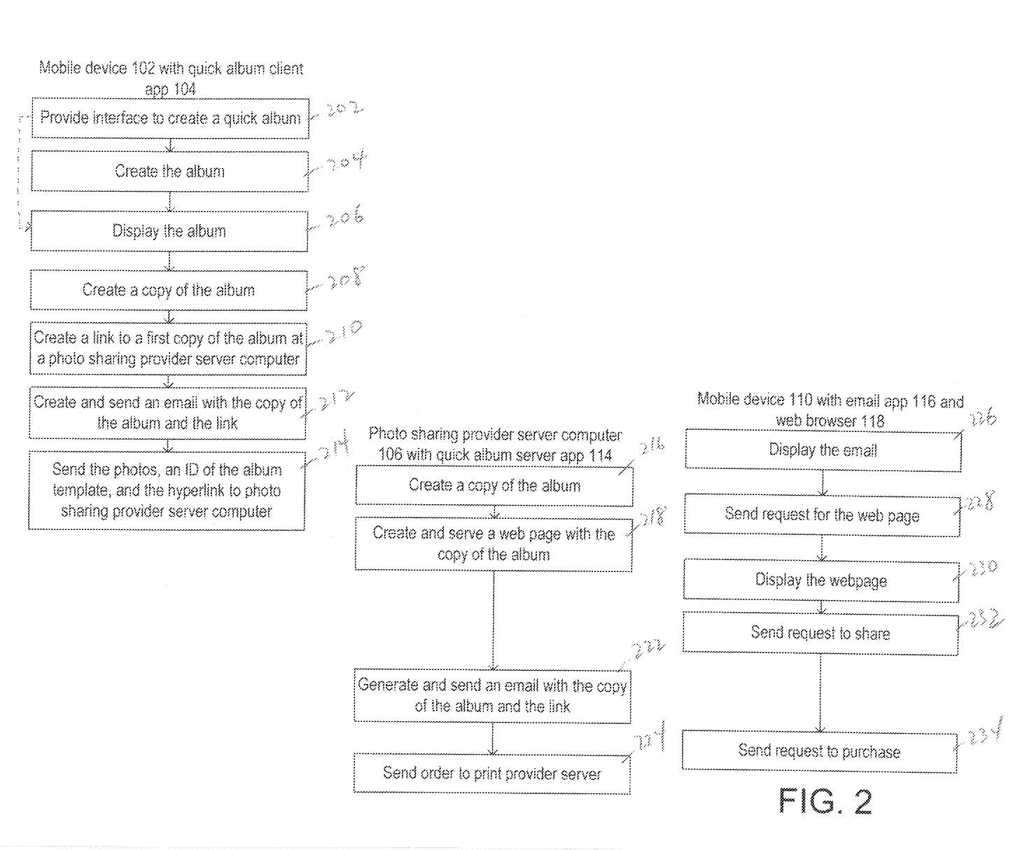

FIG. 2 is a flowchart of a method 200 executed by processors on digital device 102, photo sharing provider server computer 106, and digital device 110 of system 100 in FIG. 1 to implement photo sharing in one or more embodiments of the present disclosure. Method 200 may include one or more operations, functions, or actions illustrated by one or more blocks. Although the blocks are illustrated in sequential orders, these blocks may also be performed in parallel, and/or in a different order than those described herein. Also, the various blocks may be combined into fewer blocks, divided into additional blocks, and/or eliminated based upon the desired implementation.

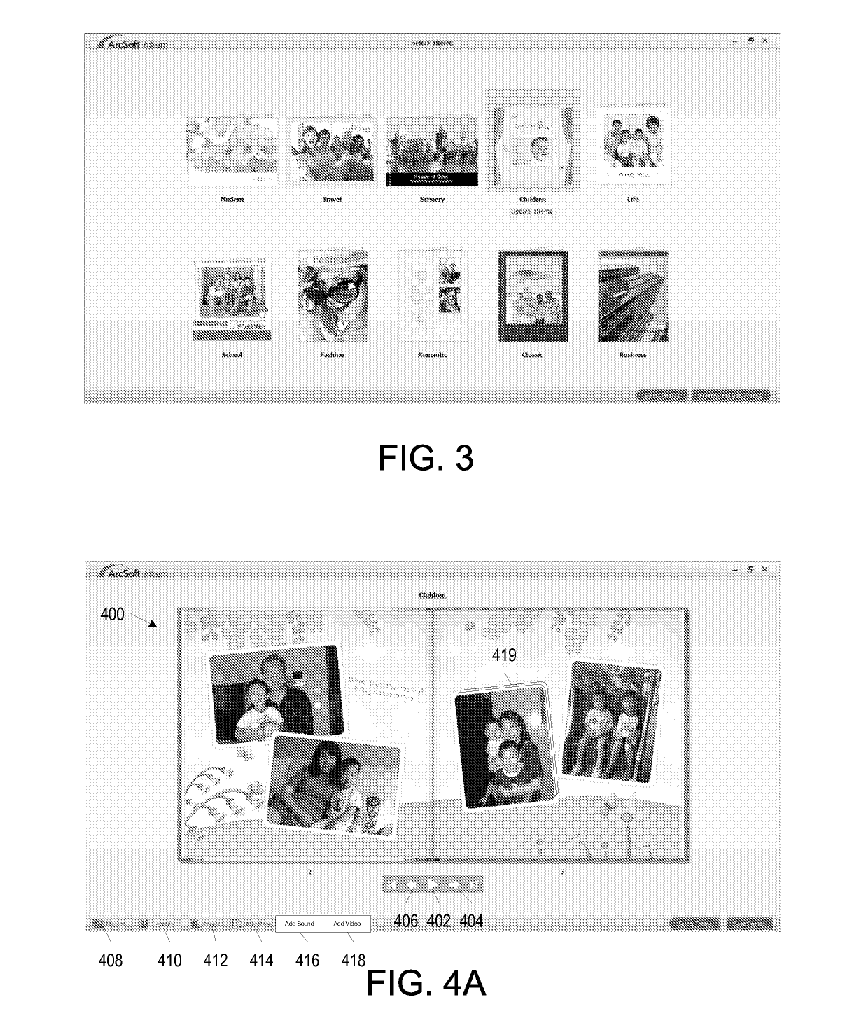

Blocks 202 to 214 are performed by the processor of digital device 102 running album client application 104 (FIG. 1). In block 202, album client application 104 on digital device 102 provides a GUI for first user 101 (FIG. 1) to create a digital album to share photos. The GUI allows first user 101 to select photos and one of multiple album templates. FIG. 3 is a screenshot of the GUI where first user 101 selects an album template in one or more embodiments of the present disclosure. Referring back to FIG. 2, block 202 may be followed by block 204. The user may also open an existing digital album, in which case block 202 may be followed by block 206.

In block 204, album client application 104 on digital device 102 (FIG. 1) automatically creates a digital album from the photos and the album template. Block 204 may be followed by block 206.

In block 206, album client application 104 on digital device 102 (FIG. 1) displays the digital album so first user 101 (FIG. 1) can view the photos and edit the digital album. FIG. 4A is a screenshot of the GUI with a digital album 400 in one or more embodiments of the present disclosure. Digital album 400 includes a play/pause button 402, a next button 404, and a previous button 406 to navigate through the pages of the album. When digital album 400 is paused, first user 101 is able to edit the photos in the photo containers on the displayed album page or pages. Within a photo container, first user 101 is able to move, rotate, and resize a photo. On the displayed album page or pages, first user 101 is able to swap the photos from one container to another and move and rotate the photo containers.

When digital album 400 is paused, additional buttons appear at the bottom of the digital album. These buttons include a photo button 408, a layout button 410, a page manage button 412, an add blank page button 414, an add sound button 416, and an add video button 418.

When first user 101 selects photo button 408, a pane with thumbnails of the selected photos appears. Using this pane, first user 101 is able to select additional photos. First user 101 is also able to drag and drop a photo from the pane into an empty container on a displayed album page or replace an existing photo in a photo container on the displayed album page.

When first user 101 selects layout button 410, a pane with thumbnails of album page templates with different layouts of photo containers appears. Using this pane, first user 101 is also able to drag and drop a new album page template from the pane into a displayed album page to replace an existing album page on the displayed album page.

When first user 101 selects a page manage button 412, a window with thumbnails of the album pages appear. Using this pane, first user 101 is able to reorder the album pages.

When first user 101 selects add blank page button 414, a blank album page is inserted and a pane with the thumbnails of the album page templates appears so the user can select the layout of the blank album page.

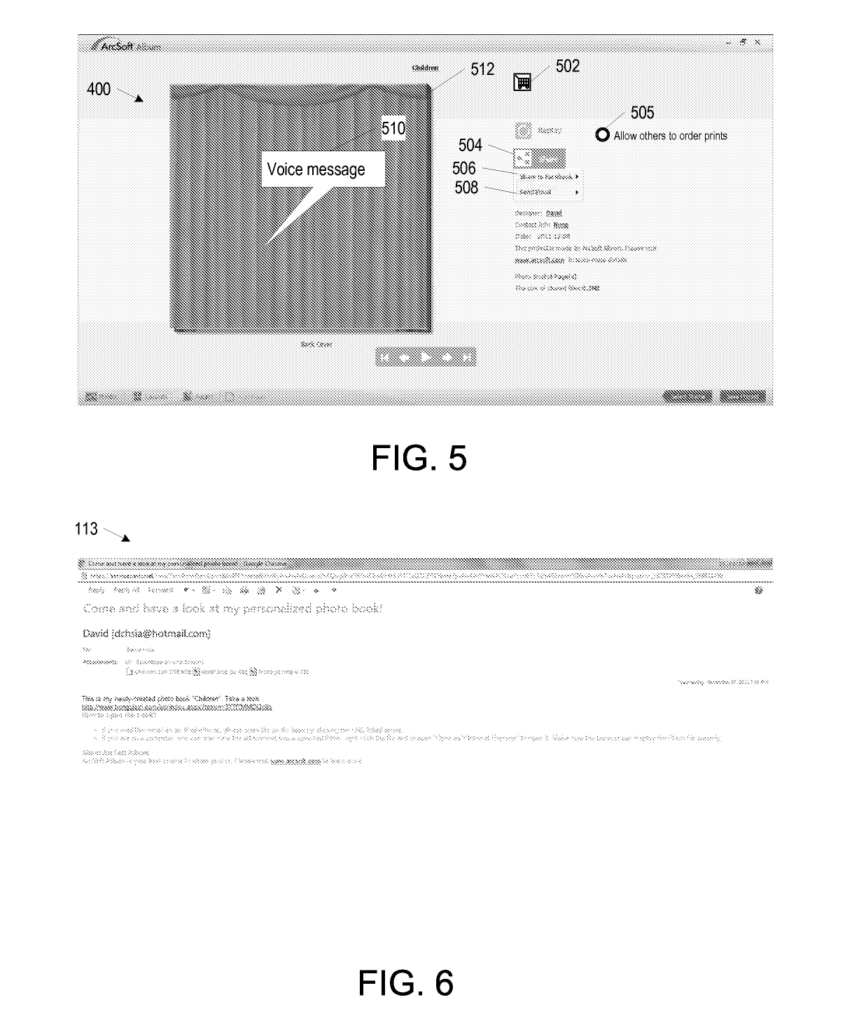

When first user 101 selects add sound button 416, a new window 420 appears for the first user to add one or more sounds to digital album 400 as shown in FIG. 4B. First user 101 (FIG. 1) clicks an add voice message button 422 to add a voice message to digital album 400. The voice message may be a greeting from first user 101. First user 101 selects one of radio buttons 424 and 426 to set the voice message to be played when the front or the back cover is displayed (e.g., FIG. 5 shows a voice message 510 is played when back cover 512 is displayed). Controls 428 are provided to record and playback the voice message. Instead of recording a new voice message, first user 101 may click attach file button 430 to select an existing voice message.

First user 101 clicks an add soundtrack button 432 to select a soundtrack for digital album 400. The soundtrack may begin after any voice message to be played with the front cover (and any video to be played on the front inside cover as described later), and ends before any voice message to be played with the back cover (and any video to be played on the back inside cover as described later). Once a soundtrack is selected, its file name 434 is displayed. Album client application 104 may recommend suitable soundtracks from local sound files on digital device 102 (FIG. 1) based on the selected album template. For this purpose, the local sound files and the album templates may be categorized ahead of time. Alternatively album client application 104 may include a mood sensing algorithm that is able to categorize the local sound files. Buttons 436, 438, and 440 are provided to accept the choices and return to the GUI of FIG. 4A, reset window 420, or cancel the choices and return to the GUI of FIG. 4A.

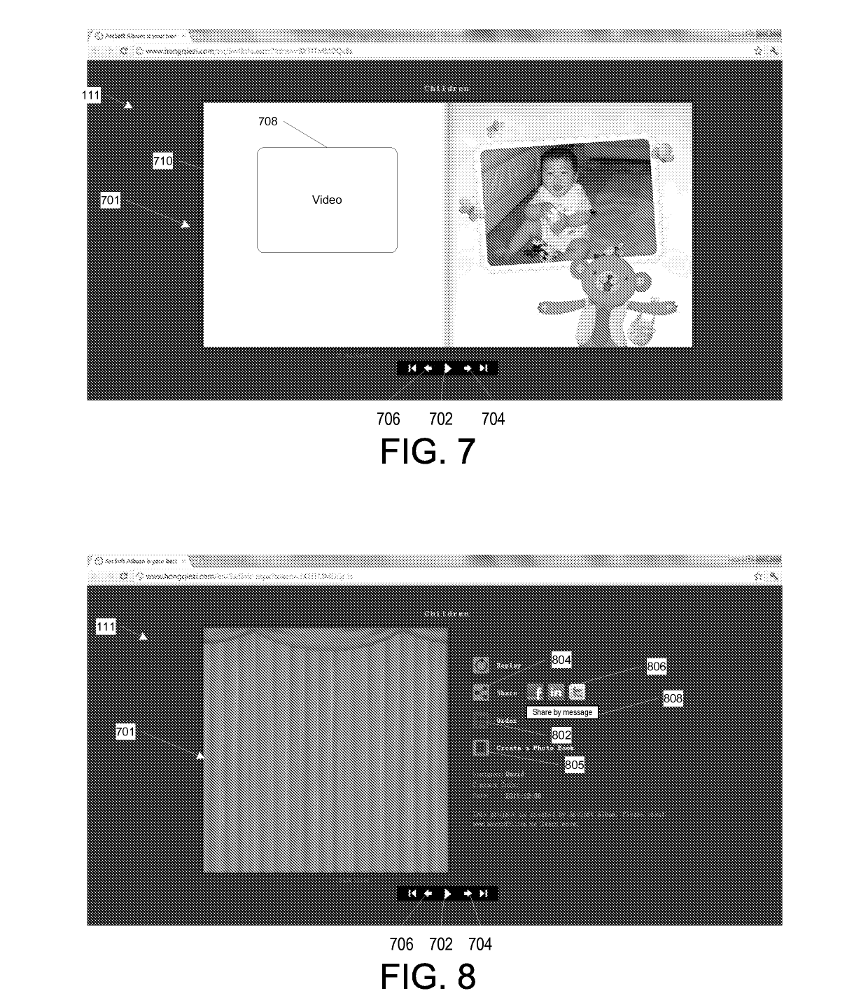

When first user 101 selects add video button 418 (FIG. 4A), a new window 450 appears for the first user to add one or more videos to digital album 400 as shown in FIG. 4C. First user 101 clicks a get video file button 452 to select a video for digital album 400. First user 101 selects one of radio buttons 454 and 456 to set the video to be played when the front or the back inside cover is displayed (e.g., FIG. 7 shows a video 708 is played on a front inside cover 710). Once a video is selected, its file name 458 is displayed. Instead of selecting an existing video, first user 101 may click capture a video file button 460 to record a new video. Any video file may be truncated (e.g., to 10 seconds) to reduce the size of digital album 400. Buttons 436, 438, and 440 are provided to accept the choices and return to the GUI of FIG. 4A, reset window 450, or cancel the choices and return to the GUI of FIG. 4A.

FIG. 5 is a screenshot of the GUI when first user 101 (FIG. 1) reaches the end of digital album 400 in one or more embodiments of the present disclosure. The GUI includes an order button 502, a share album button 504, and allow ordering radio button 505. When the first user clicks or hovers over share album button 504, the GUI provides a share through social media button 506 and a share by messaging button 508. When first user 101 clicks share through social media button 506, album client application 104 (FIG. 1) uploads digital album 400, the photos form the digital album, or a hyperlink to web page 111 (FIG. 1) to one or more social media providers. During an initial upload to a social media provider, first user 101 may first provide her user name and password for the social media provider. When first user 101 selects allow ordering radio button 505, the other users are allowed to order physical media of digital album 400 (FIG. 1).

For the purposes of explaining method 200, assume first user 101 (FIG. 1) clicks share by messaging button 508 to share digital album 400 (FIG. 4A). Referring back to FIG. 2, block 206 may be followed by block 208.

In block 208, album client application 104 on digital device 102 (FIG. 1) creates a copy of digital album 400 (FIG. 4A). As discussed above, the copy of the digital album may be a rich media file that can be viewed with or without a browser or a standalone player, and the rich media file is small in size due to its format and also because the photos in the digital album are low resolution. Block 208 may be followed by block 210.

In block 210, album client application 104 on digital device 102 (FIG. 1) creates a hyperlink to web page 111 (FIG. 1) at a photo sharing provider server computer 106. As described above, photo sharing provider server computer 106 (FIG. 1) will later create web page 111 to include a copy of digital album 400 (FIG. 4A) for other users to access and view. Block 210 may be followed by block 212.

In block 212, album client application 104 on digital device 102 (FIG. 1) causes messaging application 108 (FIG. 1) on the digital device (or another device) to create message 113 (FIG. 1), inserts the hyperlink into the body of the message, and attaches the copy of digital album 400 (FIG. 4A) to the message. FIG. 6 shows message 113 in one or more embodiments of the present disclosure. Assume first user 101 (FIG. 1) wishes to share digital album 400 with the second user 115 of digital device 110 (FIG. 1), the first user fills in the second user's messaging address on message 113 and clicks a send button to send the message to digital device 110. Block 212 may be followed by block 214.

In block 214, album client application 104 on digital device 102 (FIG. 1) transmits the photos, an identification of the album template, layout information of the album, and the hyperlink to photo sharing provider server computer 106 (FIG. 1). As discussed above, the photos may be transmitted in their full resolution to preserve their details for printing and backup purposes.

Blocks 216 to 224 are performed by the processor of photo sharing provider server computer 106 (FIG. 1) running album server application 114 (FIG. 1). In block 216, album server application 114 on photo sharing provider server computer 106 receives the photos, the identification of the album template, the layout information, and the hyperlink sent from album client application 104 on digital device 102 (FIG. 1) in block 214. Album server application 114 has the same library of album templates as album client application 104. Using the photos, the album template, and the layout information, album server application 114 recreates digital album 400 (FIG. 4A). Block 216 may be followed by block 218.

In block 218, web server 109 (FIG. 1) on photo sharing provider server computer 106 (FIG. 1) receives a request for web page 111 (FIG. 1) sent from web browser 118 on digital device 110 (FIG. 1) in block 228 (described later). In response, web server 109 passes the request to album server application 114 (FIG. 1) on photo sharing provider server computer 106. In response, album server application 114 provides a copy of digital album 400 (FIG. 4A) to web server 109, which then creates and serves web page 111 to digital device 110. As discussed above, web page 111 is small in size due to its format and also because the photos in the digital album are low resolution.

FIG. 7 is a screenshot of web page 111 with a copy 701 of digital album 400 (FIG. 4A) in one or more embodiments of the present disclosure. Copy 701 of digital album 400 includes a play/pause button 702, a next button 704, and a previous button 706 to navigate through the pages of the album.

FIG. 8 is a screenshot of web page 111 when second user 115 on digital device 110 (FIG. 1) reaches the end of copy 701 of digital album 400 (FIG. 4A) in one or more embodiments of the present disclosure. Web page 111 includes an order button 802 (if allowed by the owner of digital album 400), a share album button 804, and a create new album button 805. When second user 115 clicks or hovers over share album button 804, web page 111 provides a share through social media button 806 and a share by messaging button 808. When second user 115 clicks create new album button 805, web page 111 causes digital device 110 to launch an album client application 132 (FIG. 1) on the digital device for the second user to create a new digital album. If digital device 110 does not have album client application 132 installed, web page 111 causes web browser 118 (FIG. 1) on digital device 110 to access another web page 134 (FIG. 1) to download album client application 132. The same functionality may be provided in the copy of digital album 400 attached to message 113 (FIG. 1) where second user 115 can click create new album button 805 to launch or download album client application 132.

Referring back to FIG. 2, block 218 may be followed by block 222.

In block 222, assuming second user 115 on digital device 110 (FIG. 1) wishes to share digital album 400 (FIG. 4A) by messaging with third user 119 on digital device 120 (FIG. 1), web server 109 (FIG. 1) on photo sharing provider server computer 106 receives a request to share by message sent from web browser 118 on digital device 110 (FIG. 1) in block 232 (described later). The request includes the messaging address of third user 119. Web server 109 passes the request to album server application 114 (FIG. 1) on photo sharing provider server computer 106. Album server application 114 creates a copy of digital album 400. As discussed above, the copy of digital album 400 may be a rich media file that can be viewed with or without a browser or a standalone player, and the rich media file is small in size due to its format and also because the photos in the digital album are low resolution. Album server application 114 causes messaging application 122 (FIG. 1) on the photo sharing provider server computer 106 (or another server computer) to create message 123 (FIG. 1), inserts the hyperlink into the body of the message, attaches the copy of digital album 400 to the message, and causes the messaging application to send the message. Block 222 may be followed by block 224.

In block 224, assuming second user 115 on digital device 110 (FIG. 1) wishes to order physical media, web server 109 on photo sharing provider server computer 106 (FIG. 1) receives an order sent from web browser 118 on digital device 110 (FIG. 1) in block 234 (described later). Web server 109 passes the order to album server application 114 on photo sharing provider server computer 106. In response, album server application 114 fulfills the order or transmits the order and the photos to print provider server computer 105 to fulfill the order.

Blocks 226 to 234 are performed by the processor of digital device 110 (FIG. 1) running messaging application 116 (FIG. 1) and web browser 118 (FIG. 1). In block 226, messaging application 116 on digital device 110 displays message 113 (FIG. 1) sent from digital device 102 (FIG. 1) in block 212. Block 226 may be followed by block 228.

In block 228, assuming second user 115 on digital device 110 (FIG. 1) clicks the hyperlink in message 113, web browser 118 on digital device 110 sends a request for web page 111 (FIG. 1) to photo sharing provider server computer 106 (FIG. 1). In response, web server 109 on photo sharing provider server computer 106 (FIG. 1) serves web page 111 to web browser 118. Block 228 may be followed by block 230.

In block 230, web browser 118 (FIG. 1) displays web page 111 (FIG. 1). Block 230 may be followed by block 232.

In block 232, assuming second user 115 on digital device 110 (FIG. 1) clicks share by messaging button 808 (FIG. 8), web browser 118 (FIG. 1) on digital device 110 sends a request to share by messaging to photo sharing provider server computer 106 (FIG. 1). Block 232 may be followed by block 234.

In block 234, assuming second user 115 on digital device 110 (FIG. 1) clicks order button 802 (FIG. 8), web browser 118 (FIG. 1) on digital device 110 sends an order to photo sharing provider server computer 106 (FIG. 1).

Various other adaptations and combinations of features of the embodiments disclosed are within the scope of the present disclosure. For example, instead of digital device 102 sending message 113 with the copy of the digital album and the hyperlink, the first user may cause photo sharing provider server computer 106 to send the message. Album client application 104 transmits the photos, the identification of the album template, and the layout information of the album (e.g., photo arrangements, photo placements, photo sizes, and photo captions) to photo sharing provider server computer 106 over computer network 112. Album server application 114 recreates the copy of the digital album, causes messaging application 122 on the photo sharing provider server computer (or another server computer) to create message 113, inserts the hyperlink into the body of the message, attaches a copy of the digital album to the message, and sends the message to another user designated by the first user. Numerous embodiments are encompassed by the following claims.

What is claimed is:

1. A photo sharing method for a digital device, comprising:
creating an album from photos and an album template;
creating a link to a web page at a photo sharing provider server computer, the web page including a first copy of the album;
creating a message including a second copy of the album and the link, the second copy of the album including the photos in low resolution;
transmitting, over a network, the message to another digital device; and
transmitting, over the network, the photos in high resolution and the link to the photo sharing provider server computer.

2. The method of claim 1, wherein the second copy of the album comprises a rich media file that is self-executing or viewable on a browser with a plug-in or a standalone viewer.

3. The method of claim 1, further comprising:
receiving an order for physical media of the album; and
fulfilling the order.

4. The method of claim 1, further comprising:
uploading a third copy of the album, a number of the photos in low resolution, or the link to a social media provider server computer, wherein the social media provider server computer posts the third copy of the album, the number of the photos in low resolution, or the link to a user account for others to access.

5. The method of claim 1, further comprising displaying an advertisement based on the album template.

6. The method of claim 1, further comprising displaying the album for editing the album.

7. The method of claim 1, wherein creating the album comprises including a voice message to be played when the front or the back cover of the album is displayed.

8. The method of claim 1, wherein creating the album comprises including a soundtrack to be played when the album is displayed.

9. The method of claim 1, wherein creating the album comprises including a video file to be played when the front or the back inside cover of the album is displayed.

10. The method of claim 1, wherein creating the album comprises:
arranging the photos based on time;
grouping together similar photos taken within a short time span of each other; and
displaying the similar photos as a stack of photos in one photo container in the album so the similar photos are adapted to be flipped through by clicking on the stack.

11. A photo sharing method for a photo sharing provider server computer, comprising:
receiving photos in high resolution and a link from a first digital device over a network, the link pointing to a web page at the photo sharing provider server computer;
receiving a request for the web page from a second digital device over the network;
creating the web page including a copy of an album, the copy of the album including the photos in low resolution;
transmitting the web page to the second digital device;
receiving an order for physical media of the album from the second digital device over the network; and
directly or indirectly fulfilling the order.

12. The method of claim 11, wherein indirectly fulfilling the order comprises transmitting the order and the photos in high resolution to a print provider server computer.

13. The method of claim 11, further comprising:
creating a message including an other copy of the album and the link, the other copy of the album including the photos in low resolution; and
sending the message to a third digital device.

14. The method of claim 13, wherein the other copy of the album comprises a rich media file that is self-executing or viewable on a browser with a plug-in or a standalone viewer.

15. The method of claim 11, further comprising:
uploading an other copy of the album, a number of the photos in low resolution, or the link to a social media provider server computer, wherein the social media provider server computer posts the other copy of the album, the number of the photos in low resolution, or the link to a user account for others to access.

16. The method of claim 11, further comprising:
receiving an identification of an album template from the first digital device over the network; and
selecting an advertisement based on the album template, wherein the web page includes the advertisement.

17. The method of claim 11, further comprising:
providing a tool to generate album templates;
receiving the album templates; and
providing the album templates in a marketplace for purchase and download.

18. The method of claim 11, further comprising distributing a portion of the payment for the order to an owner of the photos.

19. A photo sharing method for a digital device, comprising:
receiving a message over a network, the message including a first copy of an album and a link to a web page at a photo sharing provider server computer, the first copy of the album including photos in low resolution;
displaying the message;
requesting the web page from the photo sharing provider server computer over the network, the web page including a second copy of the album, the second copy of the album including the photos in low resolution;
receiving and displaying the web page;
transmitting a request to share the album to the photo sharing provider server computer over the network; and
transmitting an order for physical media of the album to the photo sharing provider server computer.
